(19) United States
(12) Patent Application Publication
(10) Pub. No.: US 2025/0378974 A1
(43) Pub. Date: Dec. 11, 2025

(54) MANUFACTURING APPARATUS FOR ENAMELED COPPER WIRE AND MANUFACTURING METHOD FOR ENAMELED COPPER WIRE

(71) Applicant: Proterial, Ltd., Tokyo (JP)

(72) Inventors: Akira SETOGAWA, Tokyo (JP); Hideyuki SUZUKI, Tokyo (JP); Toshimitsu ONISHI, Tokyo (JP); Yuri MURAKAMI, Tokyo (JP); Ko KERUMA, Tokyo (JP); Yuki HONDA, Tokyo (JP); Hajime NISHI, Tokyo (JP)

(21) Appl. No.: 19/217,287

(22) Filed: May 23, 2025

(30) Foreign Application Priority Data
Jun. 11, 2024 (JP) 2024-094488
Nov. 19, 2024 (JP) 2024-201651
Feb. 20, 2025 (JP) 2025-026234

(51) Int. Cl. H01B 13/06; B21C 1/02; C23D 11/00

(52) U.S. Cl. CPC H01B 13/06; B21C 1/02; C23D 11/00

(57) ABSTRACT

A manufacturing apparatus for an enameled copper wire of the present disclosure includes a wire drawing section, an application and baking section, and a cooling section. The wire drawing section continuously performs cold wire drawing, using a wire drawing die, on a copper wire that is traveling, thereby producing a copper drawn wire. The application and baking section applies an enamel coating material to a surface of the copper drawn wire and bakes an obtained coating material film. The cooling section cools the copper wire so that a temperature of the copper drawn wire at a position that is forward of an outlet-side end face of the wire drawing die with respect to a traveling direction of the copper wire and that is 6 cm apart from the outlet-side end face is 70° C. or less.

### CROSS-REFERENCE TO RELATED APPLICATIONS

This application claims the benefit of Japanese Patent Application No. 2024-094488 filed on Jun. 11, 2024 with the Japan Patent Office, Japanese Patent Application No. 2024-201651 filed on Nov. 19, 2024 with the Japan Patent Office, and Japanese Patent Application No. 2025-026234 filed on Feb. 20, 2025 with the Japan Patent Office, the entire disclosures of which are incorporated herein by reference.

### BACKGROUND

The present disclosure relates to a manufacturing apparatus for an enameled copper wire and a manufacturing method for an enameled copper wire.

The enameled copper wire comprises a conductor and an enamel coating. The conductor is mainly made of copper. The enamel coating covers a surface of the conductor. Japanese Patent No. 6730930 describes a manufacturing method for an enameled copper wire. In the manufacturing method for an enameled copper wire, an enamel coating material is applied to the surface of the conductor to form a coating material film. Then, the coating material film is baked to form the enamel coating.

### SUMMARY

Examples of the enameled copper wire include a flat enameled copper wire. The conductor of the flat enameled copper wire is a flat copper drawn wire. The flat copper drawn wire is a conductor having a flat rectangle-like shape in its cross section. The flat copper drawn wire is produced by continuously performing cold wire drawing on a flat copper wire using a flat wire drawing die.

Wire drawing lubricant is supplied to an interface between the flat copper wire and the flat wire drawing die. When the temperature of the wire drawing lubricant increases at the interface between the flat copper wire and the flat wire drawing die, the viscosity and lubricity of the wire drawing lubricant decrease. When the viscosity and lubricity of the wire drawing lubricant decrease, friction between the flat copper wire and the flat wire drawing die increases, thus causing the flat copper wire to wear and generating copper powder. The generated copper powder adheres to the flat copper drawn wire. The copper powder adhering to the flat copper drawn wire is prone to trapping minute air bubbles when the coating material film is formed. The minute air bubbles foam when the coating material film is baked, thus generating apparently abnormal parts in the flat enameled copper wire.

In one aspect of the present disclosure, it is desirable to provide a manufacturing apparatus for an enameled copper wire and a manufacturing method for an enameled copper wire in which generation of apparently abnormal parts can be inhibited.

One aspect of the present disclosure provides a manufacturing apparatus for an enameled copper wire. The manufacturing apparatus comprises: a wire drawing section configured to continuously perform cold wire drawing, using a wire drawing die, on a copper wire that is traveling, thereby producing a copper drawn wire; an application and baking section configured to apply an enamel coating material to a surface of the copper drawn wire and to bake an obtained coating material film; and a cooling section configured to cool the copper wire so that a temperature of the copper drawn wire at a position that is forward of an outlet-side end face of the wire drawing die with respect to a traveling direction of the copper wire and that is 6 cm apart from the outlet-side end face is 70° C. or less. This manufacturing apparatus makes it possible to inhibit generation of apparently abnormal parts.

Another aspect of the present disclosure provides a manufacturing method for an enameled copper wire. The manufacturing method comprises: continuously performing cold wire drawing, using a wire drawing die, on a copper wire that is traveling, thereby producing a copper drawn wire; applying an enamel coating material to a surface of the copper drawn wire and baking an obtained coating material film; and cooling the copper wire so that a temperature of the copper drawn wire at a position that is forward of an outlet-side end face of the wire drawing die with respect to a traveling direction of the copper wire and that is 6 cm apart from the outlet-side end face is 70° C. or less. This manufacturing method makes it possible to inhibit generation of apparently abnormal parts.

### BRIEF DESCRIPTION OF THE DRAWINGS

Example embodiments of the present disclosure will be described hereinafter with reference to the accompanying drawings, in which:

FIG. 1 is an explanatory diagram showing a configuration of a manufacturing apparatus for a flat enameled copper wire;

FIG. 2 is a sectional view showing a cross-sectional shape of a flat copper wire;

FIG. 3 is a sectional view showing a cross-sectional shape of a flat copper drawn wire;

FIG. 4 is an explanatory diagram showing a configuration of a flat wire drawing machine of the first embodiment;

FIG. 5 is an explanatory diagram showing a configuration of a flat wire drawing machine of the second embodiment;

FIG. 6 is an explanatory diagram showing a configuration of a cooling section of another embodiment;

FIG. 7 is an explanatory diagram showing a configuration of a flat wire drawing machine of the third embodiment;

FIG. 8 is a graph showing a relationship between a wire drawing lubricant temperature and an average of the number of defects in appearance; FIG. 9 is an explanatory diagram showing a configuration of a flat wire drawing machine of the fourth embodiment; and

FIG. 10 is an explanatory diagram showing a configuration of a nozzle unit and so on of the fourth embodiment.

### DETAILED DESCRIPTION OF EXEMPLARY EMBODIMENTS

### First Embodiment

### 1. Overview of Manufacturing Method for Flat Enameled Copper Wire

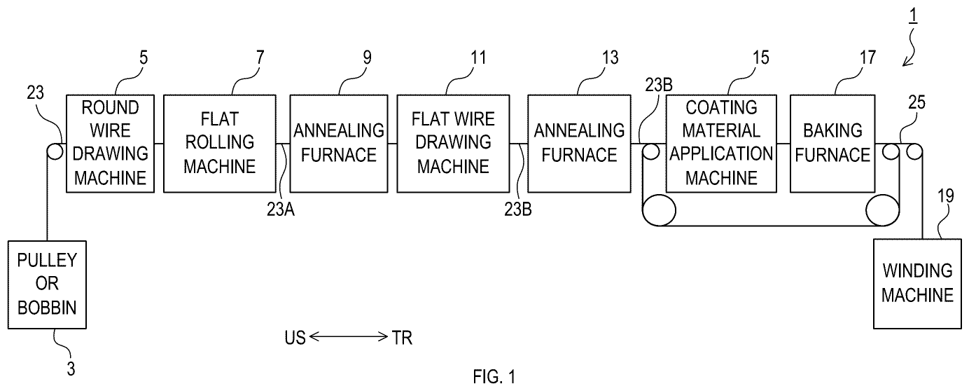

Overview of a manufacturing method for a flat enameled copper wire will be described with reference to FIGS. 1 to 3. The flat enameled copper wire corresponds to an example of an enameled copper wire. The manufacturing method for the flat enameled copper wire uses a manufacturing apparatus 1 for a flat enameled copper wire shown in FIG. 1. The manufacturing apparatus 1 for the flat enameled copper wire comprises a pulley or bobbin 3, a round wire drawing machine 5, a flat rolling machine 7, an annealing furnace 9, a flat wire drawing machine 11, an annealing furnace 13, a coating material application machine 15, a baking furnace 17, and a wind-up machine 19. The flat wire drawing machine 11 corresponds to an example of a wire drawing section. The coating material application machine 15 and the baking furnace 17 correspond to an example of an application and baking section.

The application and baking section may be understood to include an application section and a baking section. The coating material application machine 15 performs application of a coating material. The coating material application machine 15 may be understood to be the application section. The baking furnace 17 performs baking. The baking furnace 17 may be understood to be the baking section.

A conductor 23 having a linear shape is wound around the pulley or bobbin 3. The conductor 23 is drawn out from the pulley or bobbin 3, travels along a path that passes through the round wire drawing machine 5, the flat rolling machine 7, the annealing furnace 9, the flat wire drawing machine 11, the annealing furnace 13, the coating material application machine 15, and the baking furnace 17 in this order, and is wound up by the wind-up machine 19. Note that a flat copper drawn wire 23B to be described below, which is the conductor 23 subjected to some processes, travels a section including the coating material application machine 15 and the baking furnace 17 multiple times.

A material for the conductor 23 is copper or a copper alloy. Thus, the conductor 23 is a copper wire. A cross-sectional shape of the conductor 23 is circular until a flat rolling to be described below is performed. The cross section of the conductor 23 refers to a section perpendicular to a longitudinal axis of the conductor 23.

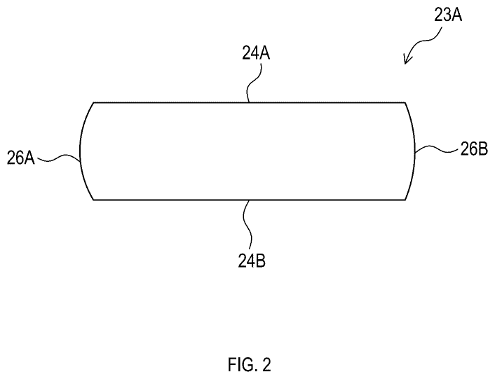

The round wire drawing machine 5 draws the conductor 23 having a circular cross-sectional shape. The flat rolling machine 7 performs the flat rolling on the conductor 23 traveling therethrough. The conductor 23 that has undergone the flat rolling is referred to as a flat copper wire 23A. As shown in FIG. 2, a cross-sectional shape of the flat copper wire 23A is a shape formed by two sides 24A and 24B parallel to each other and two arc-shaped lines 26A and 26B. In the cross section, the shape of the sides 24A and 24B is linear. In the cross section, the length of the sides 24A and 24B is longer than the length of the arc-shaped lines 26A and 26B. The annealing furnace 9 anneals the flat copper wire 23A.

The flat wire drawing machine 11 performs a flat wire drawing on the flat copper wire 23A traveling therethrough. The flat wire drawing is a process of continuously performing cold wire drawing on the flat copper wire 23A using a flat wire drawing die 31 to be described below. The conductor 23 that has undergone the flat wire drawing is the flat copper drawn wire 23B. The detailed configuration of the flat wire drawing machine 11 will be described below.

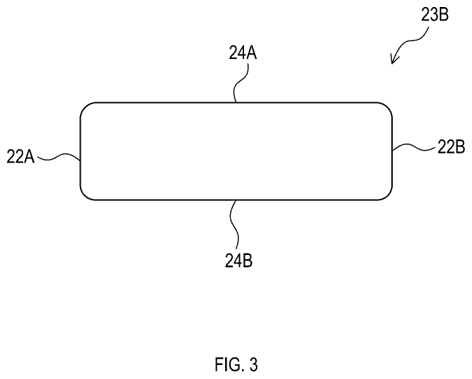

A cross-sectional shape of the flat copper drawn wire 23B is a rounded rectangle as shown in FIG. 3. Longer sides of the rounded rectangle are the sides 24A and 24B. Shorter sides 22A and 22B of the rounded rectangle are sides derived from the arc-shaped lines 26A and 26B, respectively, in the flat copper wire 23A.

As shown in FIG. 1, in the flat wire drawing machine 11 (in the manufacturing apparatus 1), a direction in which the conductor 23 travels is referred to as a traveling direction TR. A direction opposite to the traveling direction TR is referred to as an upstream direction US. The annealing furnace 13 anneals the flat copper drawn wire 23B. The coating material application machine 15 applies an enamel coating material to a surface of the flat copper drawn wire 23B to thereby form a film of the enamel coating material of a given thickness on the surface of the flat copper drawn wire 23B.

The baking furnace 17 applies heat to the flat copper drawn wire 23B traveling therethrough, on which the film of the enamel coating material of the given thickness has been formed by the coating material application machine 15, to bake the coating material film, thus forming a coating. As shown in FIG. 1, the application of the enamel coating material by the coating material application machine 15 and the formation of the coating by the baking furnace 17 are repeatedly performed. This results in manufacturing a flat enameled copper wire 25 of a given coating thickness. The flat enameled copper wire 25 is wound up by the wind-up machine 19.

A method for forming an enamel coating is, for example, as follows.

The enamel coating material is applied to the surface of the flat copper drawn wire 23B. The enamel coating material is a coating material containing, for example, a resin and a solvent. Next, the solvent in the enamel coating material applied to the surface of the flat copper drawn wire 23B is evaporated, and the resin in the enamel coating material is cured. After the evaporation of the solvent and the cure of the resin, the flat enameled copper wire 25 is formed.

### 2. Configuration of Flat Wire Drawing Machine 11

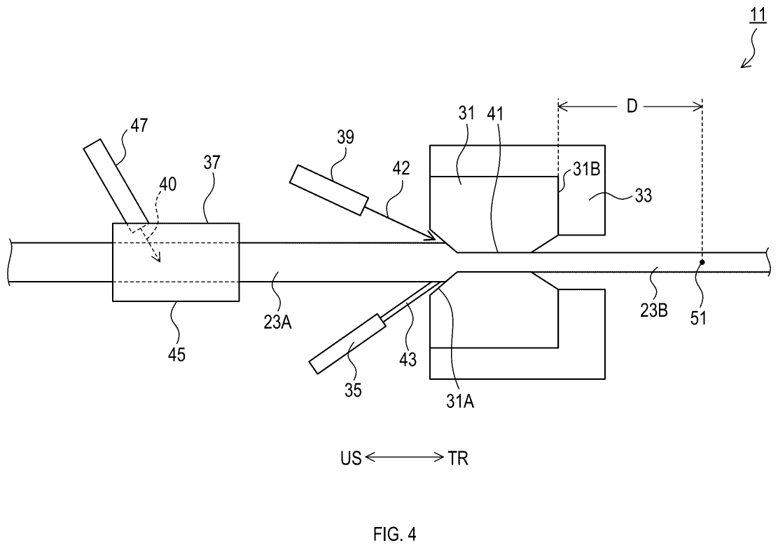

The configuration of the flat wire drawing machine 11 is described with reference to FIG. 4. The flat wire drawing machine 11 comprises the flat wire drawing die 31, a die holder 33, a jet nozzle 35, a first cooling section 37, and a second cooling section 39.

The flat wire drawing die 31 produces the flat copper drawn wire 23B by continuously performing cold wire drawing on the flat copper wire 23A. The flat wire drawing die 31 contains a processing hole 41 having a flat shape. The conductor 23 passes through the processing hole 41 while traveling in the traveling direction TR. The conductor 23 before passing through the processing hole 41 is the flat copper wire 23A. The conductor 23 after passing through the processing hole 41 is the flat copper drawn wire 23B. The speed at which the flat copper wire 23A enters the flat wire drawing die 31 is, for example, 15.5 m/min.

The die holder 33 holds the flat wire drawing die 31. The jet nozzle 35 jets out a wire drawing lubricant 43 at an inlet-side part 31A of the flat wire drawing die 31. Examples of the wire drawing lubricant 43 include that containing water and a surfactant, that of the emulsion type, and so on. Commercially available examples of the wire drawing lubricant 43 include “METALSHIN N-150 Conch” manufactured by Kyoeisha Chemical Co., Ltd.

The first cooling section 37 is provided upstream of the flat wire drawing die 31 with respect to the upstream direction US. The first cooling section 37 comprises a tubular section 45 and a vortex cooler 47. The tubular section 45 is a hollow tubular member. An axial direction of the tubular section 45 is parallel to the upstream direction US. The flat copper wire 23A passes through the tubular section 45 and travels toward the flat wire drawing die 31.

The vortex cooler 47 is attached to the tubular section 45. The vortex cooler 47 supplies a cold air 40 to the inside of the tubular section 45. This allows the flat copper wire 23A to be cooled as it passes through the tubular section 45. The first cooling section 37 is a unit configured to cool the flat copper wire 23A with the cold air 40.

The second cooling section 39 is a vortex cooler. The second cooling section 39 blows out a cold air 42 at the inlet-side part 31A of the flat wire drawing die 31. Thus, part of the flat copper wire 23A located near the inlet-side part 31A is cooled. The inlet-side part 31A is also cooled. The second cooling section 39 is a unit configured to cool the flat copper wire 23A with the cold air 42.

The first cooling section 37 and the second cooling section 39 are controlled so that the temperature of the flat copper drawn wire 23B at a temperature measurement position 51 is 70° C. or less. The control of the first cooling section 37 and the second cooling section 39 may be performed by a control section including a computer or may be performed by a worker. The higher the temperature of the flat copper drawn wire 23B at the temperature measurement position 51 is, the more strongly the first cooling section 37 and the second cooling section 39 cool the flat copper wire 23A.

The temperature measurement position 51 is on the flat copper drawn wire 23B. The temperature measurement position 51 is apart from an outlet-side end face 31B of the flat wire drawing die 31 in the traveling direction TR. A distance D from the outlet-side end face 31B to the temperature measurement position 51 is 6 cm. The distance D is a distance along the traveling direction TR. A method for measuring the temperature at the temperature measurement position 51 is a method using a thermocouple.

### 3. Effects Produced by Manufacturing Apparatus 1 and Manufacturing Method for Flat Enameled Copper Wire

(1A) The manufacturing apparatus 1 for the flat enameled copper wire cools the flat copper wire 23A using the first cooling section 37 and the second cooling section 39 so that the temperature of the flat copper drawn wire 23B at the temperature measurement position 51 is 70° C. or less.

The temperature of the flat copper drawn wire 23B at the temperature measurement position 51 is close to the temperature at an interface between the flat copper wire 23A and the flat wire drawing die 31. Thus, the manufacturing apparatus 1 for the flat enameled copper wire enables the interface between the flat copper wire 23A and the flat wire drawing die 31 to have a temperature of approximately 70° C. or less.

Accordingly, the temperature of the wire drawing lubricant 43 is less likely to increase at the interface between the flat copper wire 23A and the flat wire drawing die 31. When the temperature of the wire drawing lubricant 43 is less likely to increase, the viscosity and lubricity of the wire drawing lubricant 43 are less likely to decrease. For example, if the wire drawing lubricant 43 contains water and a surfactant, when the temperature of the wire drawing lubricant 43 is less likely to increase, the viscosity of the wire drawing lubricant 43 is less likely to decrease. Moreover, when the temperature of the wire drawing lubricant 43 is less likely to increase, the surfactant is less likely to precipitate from the water; thus, the lubricity of the wire drawing lubricant 43 is less likely to decrease. When the viscosity and lubricity of the wire drawing lubricant 43 are less likely to decrease, friction between the flat copper wire 23A and the flat wire drawing die 31 is less likely to increase, the flat copper wire 23A is less likely to wear, and copper powder is less likely to be generated. Consequently, apparently abnormal parts are less likely to be generated in the flat enameled copper wire 25.

(1B) In the manufacturing apparatus 1 for the flat enameled copper wire, the first cooling section 37 and the second cooling section 39 are used to cool the flat copper wire 23A. This allows the effect of cooling the flat copper wire 23A to be further enhanced. Moreover, the vortex coolers are used in the first cooling section 37 and the second cooling section 39. Sinc the vortex coolers generate wind pressure, copper powder and/or foreign matters on the surface of the flat copper wire 23A can be removed. This results in improving the adhesion between the conductor 23 and the enamel coating. Furthermore, when the vortex coolers are used, costs for manufacturing the flat enameled copper wire 25 can be reduced as compared with a case of cooling the entire building in which the manufacturing apparatus 1 is installed.

### Second Embodiment

1. Differences from First Embodiment

Since the second embodiment has the same basic configuration as the first embodiment, descriptions will be given below as to differences therebetween. The same reference numerals as in the first embodiment indicate the same elements, and the preceding descriptions are to be referred to.

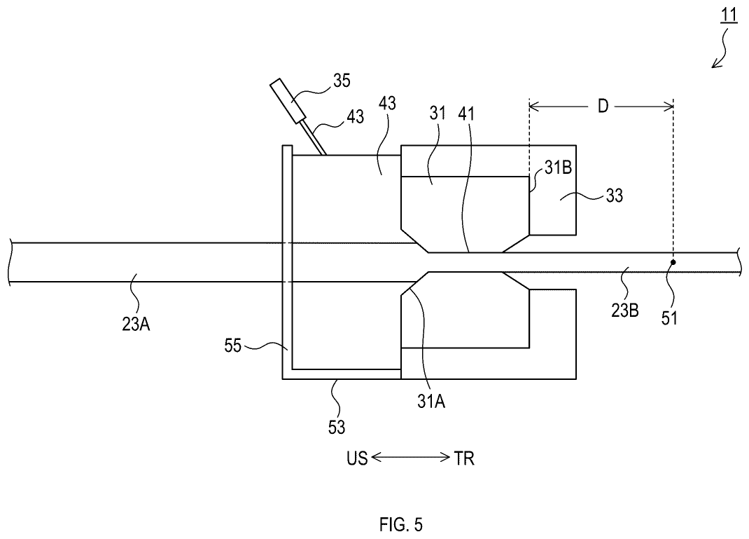

In the first embodiment described above, the flat wire drawing machine 11 comprises the first cooling section 37 and the second cooling section 39. In this regard, in the second embodiment shown in FIG. 5, the flat wire drawing machine 11 differs from that of the first embodiment in that it comprises a third cooling section 53 instead of the first cooling section 37 and the second cooling section 39.

The third cooling section 53 is adjacent to the flat wire drawing die 31 and is provided upstream of the flat wire drawing die 31 with respect to the upstream direction US. The third cooling section 53 comprises a tank 55 and the wire drawing lubricant 43 stored in the tank 55. The wire drawing lubricant 43 stored in the tank 55 is cooled by a not-shown cooling device. The jet nozzle 35 supplies the wire drawing lubricant 43 into the tank 55. The wire drawing lubricant 43 stored in the tank 55 is in contact with the inlet-side part 31A.

The flat copper wire 23A passes through the wire drawing lubricant 43 stored in the tank 55 and travels toward the flat wire drawing die 31. The flat copper wire 23A is cooled when passing through the wire drawing lubricant 43 stored in the tank 55. The third cooling section 53 is controlled so that the temperature of the flat copper drawn wire 23B at the temperature measurement position 51 is 70° C. or less. The control of the third cooling section 53 may be performed by a control section including a computer or may be performed by a worker. The higher the temperature of the flat copper drawn wire 23B at the temperature measurement position 51 is, the more strongly the wire drawing lubricant 43 stored in the tank 55 is cooled.

### 2. Effects Produced by Manufacturing Apparatus 1 and Manufacturing Method for Flat Enameled Copper Wire

The second embodiment detailed above produces the above-described effect (1A) of the first embodiment and further produces the following effect. (2A) In the manufacturing apparatus 1 for the flat enameled copper wire, the third cooling section 53 is used to cool the flat copper wire 23A. This allows the effect of cooling the flat copper wire 23A to be further enhanced.

### Third Embodiment

1. Differences from First Embodiment

Since the third embodiment has the same basic configuration as the first embodiment, descriptions will be given below as to differences therebetween. The same reference numerals as in the first embodiment indicate the same elements, and the preceding descriptions are to be referred to.

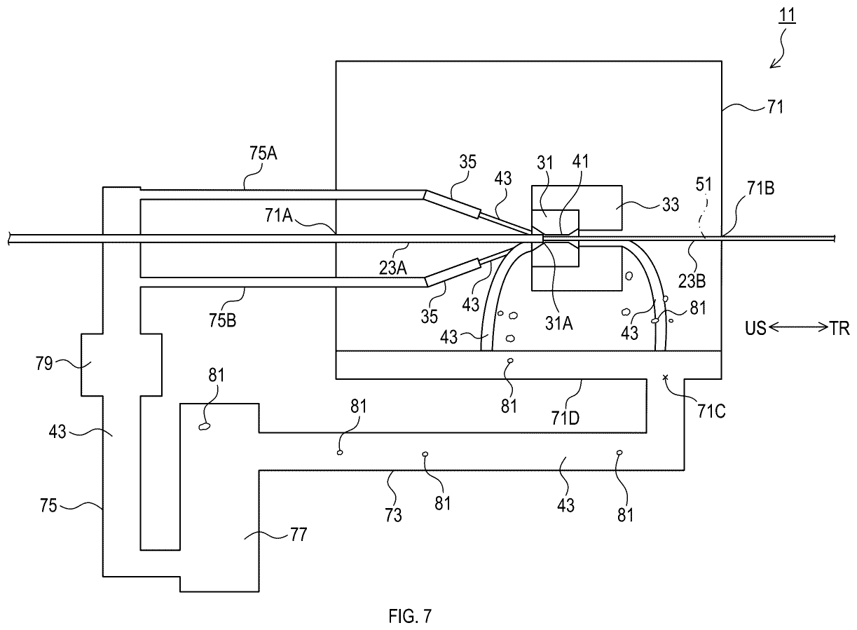

In the first embodiment described above, the flat wire drawing machine 11 comprises the first cooling section 37 and the second cooling section 39. In this regard, in the third embodiment shown in FIG. 7, the flat wire drawing machine 11 differs from that of the first embodiment in that it comprises a wire drawing die box 71 and a circulation device 73 and it comprises two jet nozzles 35.

The wire drawing die box 71 is a hollow box-shaped member. The wire drawing die box 71 houses therein the flat wire drawing die 31, the die holder 33, and the two jet nozzles 35. The wire drawing die box 71 comprises an inlet 71A and an outlet 71B. The inlet 71A is a hole formed in the wire drawing die box 71 on the upstream side thereof with respect to the upstream direction US. The outlet 71B is a hole formed in the wire drawing die box 71 on the traveling forward side thereof with respect to the traveling direction TR.

The traveling conductor 23 enters the wire drawing die box 71 through the inlet 71A and exits the wire drawing die box 71 through the outlet 71B. The wire drawing die box 71 comprises a discharge hole 71C. The discharge hole 71C is a hole formed in a bottom 71D of the wire drawing die box 71.

The circulation device 73 comprises a pipe 75, a filter 77, and a cooling section 79. The pipe 75 extends from the discharge hole 71C to the two jet nozzles 35. The pipe 75 branches into branch pipes 75A and 75B near the two jet nozzles 35. The branch pipe 75A is connected to one of the jet nozzles 35, and the branch pipe 75B is connected to the other one of the jet nozzles 35. The pipe 75 is located outside the wire drawing die box 71 except for part of the branch pipes 75A and 75B.

The wire drawing lubricant 43 jetted out from the two jet nozzles 35 hits the inlet-side part 31A of the flat wire drawing die 31, then falls onto the bottom 71D, and then enters the pipe 75 through the discharge hole 71C. After hitting the inlet-side part 31A, some of the wire drawing lubricant 43 passes through the processing hole 41 and falls onto the bottom 71D.

The wire drawing lubricant 43 that has entered the pipe 75 flows through the pipe 75 and is delivered to the two jet nozzles 35. The wire drawing lubricant 43 delivered to the two jet nozzles 35 is jetted out again from the two jet nozzles 35. A not-shown pump causes the wire drawing lubricant 43 to flow in this way.

The filter 77 is arranged midway through the pipe 75. The wire drawing lubricant 43 flowing through the pipe 75 passes through the filter 77. The wire drawing lubricant 43 falling from the flat wire drawing die 31 onto the bottom 71D contains copper powder 81. The filter 77 collects the copper powder 81. Thus, the number of the copper powder 81 contained in the wire drawing lubricant 43 that has passed through the filter 77 is less than the number of the copper powder 81 contained in the wire drawing lubricant 43 before passing through the filter 77.

The cooling section 79 is arranged midway through the pipe 75. The cooling section 79 is located downstream of the filter 77, for example. Downstream here refers to downstream with respect to a direction in which the wire drawing lubricant 43 flows. The cooling section 79 cools the wire drawing lubricant 43 flowing through the pipe 75.

The cooling section 79 is controlled so that the temperature of the wire drawing lubricant 43 jetted out from the jet nozzles 35 (hereinafter referred to as a wire drawing lubricant temperature) is less than 26° C. The control of the cooling section 79 may be performed by a control section including a computer or may be performed by a worker. The higher the wire drawing lubricant temperature is, the more strongly the cooling section 79 cools the wire drawing lubricant 43.

A method for measuring the wire drawing lubricant temperature is as follows. A thermocouple is attached to an outer circumferential surface of the jet nozzle 35, and a heat insulating material is wrapped around the outside of the thermocouple. In this state, the temperature is measured by the thermocouple. Since the jet nozzle 35 is made of metal and has a high thermal conductivity, the temperature of the jet nozzle 35 measured by the thermocouple can be regarded as the wire drawing lubricant temperature.

When the wire drawing lubricant temperature is less than 26° C., the temperature of the flat copper drawn wire 23B at the temperature measurement position 51 is 70° C. or less. Thus, the cooling section 79 is controlled so that the temperature of the flat copper drawn wire 23B at the temperature measurement position 51 is 70° C. or less.

### 2. Effects Produced by Manufacturing Apparatus 1 and Manufacturing Method for Flat Enameled Copper Wire

The third embodiment detailed above produces the above-described effect (1A) of the first embodiment and further produces the following effect.

(3A) The cooling section 79 cools the wire drawing lubricant 43. The jet nozzles 35 jet out the cooled wire drawing lubricant 43 at the inlet-side part 31A of the flat wire drawing die 31. The cooled wire drawing lubricant 43 cools the flat copper wire 23A. That is, the cooling section 79 cools the flat copper wire 23A with the cooled wire drawing lubricant 43. The wire drawing lubricant temperature is less than 26° C. This allows the effect of cooling the flat copper wire 23A to be further enhanced. The cooled wire drawing lubricant 43 corresponds to a cooled liquid.

### 3. Examples

The flat enameled copper wire 25 was manufactured using the manufacturing apparatus 1 for the flat enameled copper wire of the present embodiment. When manufacturing the flat enameled copper wire 25, the wire drawing lubricant temperature was changed variously. For each wire drawing lubricant temperature, the average of the number of defects in appearance in the manufactured flat enameled copper wire 25 was calculated.

The method for detecting the defects in appearance in the flat enameled copper wire 25 was that described in Japanese Unexamined Patent Application Publication No. 2019-138814. Specifically, the method was as follows. At a position X on a surface of the flat enameled copper wire 25, the surface height is measured using an optical displacement sensor. The surface height is a difference in height between a normal part and a projecting part on the surface of the flat enameled copper wire 25.

Moreover, at the position X, the surface of the flat enameled copper wire 25 is photographed using a CCD camera to obtain an image. Next, the image is processed to detect a shape included in the image. Then, an area of the detected shape is calculated.

At the position X, if the surface height exceeds a reference value or if the area of the shape exceeds a reference value, it is determined that a defect in appearance is present at the position X. On the other hand, at the position X, if the surface height does not exceed the reference value and if the area of the shape does not exceed the reference value, it is determined that no defect in appearance is present at the position X. Such measurements and determinations are repeatedly performed while changing the position X. The average of the number of the defects in appearance is calculated based on these results.

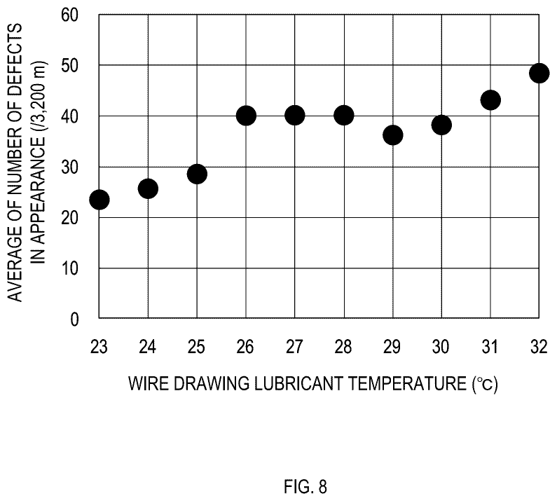

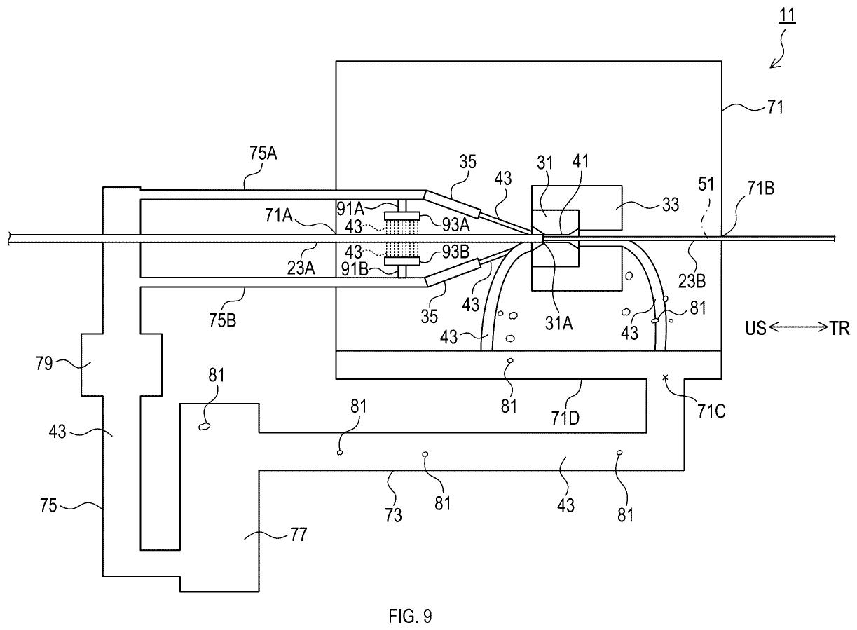

The average of the number of the defects in appearance at each wire drawing lubricant temperature is shown in FIG. 8. This average is an average per the length of 3,200 m of the flat enameled copper wire 25. When the wire drawing lubricant temperature is less than 26° C., the average of the number of the defects in appearance was less. When the wire drawing lubricant temperature is 25° C. or less, the average of the number of the defects in appearance was particularly less. When the wire drawing lubricant temperature is less than 26° C., the temperature of the flat copper drawn wire 23B at the temperature measurement position 51 was 70° C. or less.

### Fourth Embodiment

1. Differences from Third Embodiment

Since the fourth embodiment has the same basic configuration as the third embodiment, descriptions will be given below as to differences therebetween. The same reference numerals as in the third embodiment indicate the same elements, and the preceding descriptions are to be referred to.

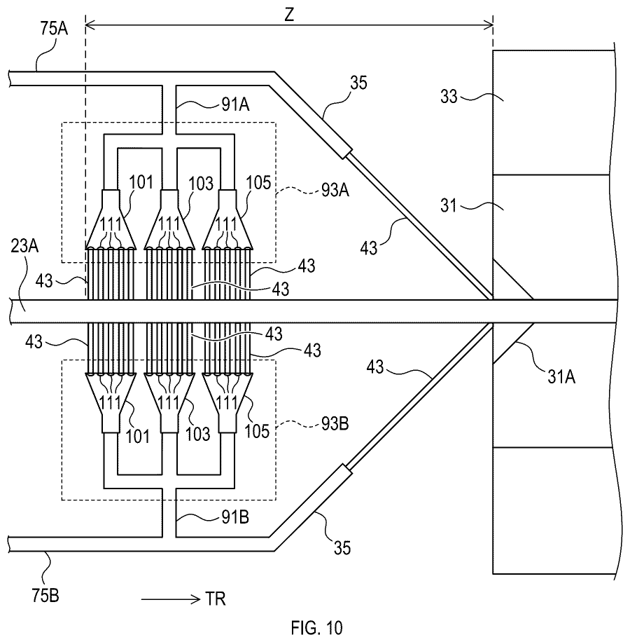

As shown in FIGS. 9 and 10, in the fourth embodiment, the flat wire drawing machine 11 further comprises pipes 91A and 91B, and nozzle units 93A and 93B. The pipe 91A is a pipe that further branches from the branch pipe 75A. The pipe 91B is a pipe that further branches from the branch pipe 75B.

The nozzle unit 93A is a unit that jets out a supplied liquid. The nozzle unit 93A is above the flat copper wire 23A. The nozzle unit 93A comprises three coolant flared nozzles 101, 103, and 105. The coolant flared nozzles 101, 103, and 105 are arranged in a single row along the traveling direction TR. The coolant flared nozzles 101, 103, and 105 each include multiple holes 111. The multiple holes 111 of the coolant flared nozzles 101, 103, and 105 are arranged in a single row along the traveling direction TR. The multiple holes 111 of the coolant flared nozzles 101, 103, and 105 are opened downward to face the flat copper wire 23A.

The pipe 91A branches into three pipes, and the three pipes are each connected to a corresponding one of the coolant flared nozzles 101, 103, and 105. The wire drawing lubricant 43 flows into the coolant flared nozzles 101, 103, and 105 via the branch pipe 75A and the pipe 91A. Then, the wire drawing lubricant 43 is jetted out through the multiple holes 111 of the coolant flared nozzles 101, 103, and 105 and is applied to the surface of the flat copper wire 23A.

The nozzle unit 93B has a configuration similar to that of the nozzle unit 93A. However, the nozzle unit 93B is below the flat copper wire 23A.

In addition, in the nozzle unit 93B, the multiple holes 111 of the coolant flared nozzles 101, 103, and 105 are opened upward to face the flat copper wire 23A.

The pipe 91B branches into three pipes, and the three pipes are each connected to a corresponding one of the coolant flared nozzles 101, 103, and 105 of the nozzle unit 93B. The wire drawing lubricant 43 flows into the coolant flared nozzles 101, 103, and 105 of the nozzle unit 93B via the branch pipe 75B and the pipe 91B. Then, the wire drawing lubricant 43 is jetted out through the multiple holes 111 of the coolant flared nozzles 101, 103, and 105 and is applied to the surface of the flat copper wire 23A.

The cooling section 79 is controlled so that the wire drawing lubricant temperature of the wire drawing lubricant 43 jetted out from the jet nozzles 35 and the nozzle units 93A and 93B is less than 26° C. The control of the cooling section 79 may be performed by a control section including a computer or may be performed by a worker. The higher the wire drawing lubricant temperature is, the more strongly the cooling section 79 cools the wire drawing lubricant 43.

A method for measuring the wire drawing lubricant temperature is the same as that of the third embodiment. When the wire drawing lubricant temperature is less than 26° C., the temperature of the flat copper drawn wire 23B at the temperature measurement position 51 is 70° C. or less. Thus, the cooling section 79 is controlled so that the temperature of the flat copper drawn wire 23B at the temperature measurement position 51 is 70° C. or less. The temperature of the flat copper drawn wire 23B at the temperature measurement position 51 is preferably 60° C. or less. By lowering the wire drawing lubricant temperature, the temperature of the flat copper drawn wire 23B at the temperature measurement position 51 can be 60° C. or less.

As shown in FIG. 10, the length, along the traveling direction TR, of a section where the nozzle units 93A and 93B and the jet nozzles 35 jet out the wire drawing lubricant 43 is represented by Z. The unit for Z is m. It is preferable that the following expression (1) is satisfied.

$$Z > 0.05 XY \qquad Expression ( 1 )$$

In Expression (1), X is the wire drawing lubricant temperature. The unit for X is ° C. X is, for example, 20° C. or less. In Expression (1), Y is a wire speed of the flat copper wire 23A. The unit for Y is m/min. Y is, for example, 30 m/min or less. When Expression (1) is satisfied, the effect of cooling the flat copper wire 23A is further enhanced. When Expression (1) is satisfied, for example, the temperature of the flat copper wire 23A immediately before the flat wire drawing die 31 can be 25° C. or less.

### 2. Effects Produced by Manufacturing Apparatus 1 and Manufacturing Method for Flat Enameled Copper Wire

The fourth embodiment detailed above produces the above-described effects of the third embodiment and further produces the following effect.

(4A) The nozzle units 93A and 93B include the multiple holes 111 arranged in a single row along the traveling direction TR. The cooled wire drawing lubricant 43 is jetted out at the flat copper wire 23A through each of the multiple holes 111. The jetted-out wire drawing lubricant 43 is applied to the surface of the flat copper wire 23A to cool the flat copper wire 23A.

These configurations and the jet nozzle 35 allow any point on the flat copper wire 23A to be continuously cooled with the wire drawing lubricant 43 during a period in which the point travels the section with the length of Z. Consequently, the effect of cooling the flat copper wire 23A is further enhanced.

### Other Embodiments

Although the embodiments of the present disclosure have been described so far, the present disclosure is not limited to the above-described embodiments and can be carried out in variously deformed forms.

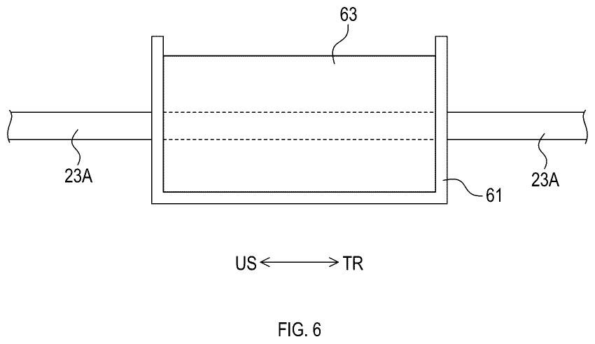

(1) The method for cooling the conductor 23 may be a method using, for example, an air conditioning system of the building in which the manufacturing apparatus 1 is installed. The lower the temperature inside the building is, the more the conductor 23 can be cooled. Alternatively, the method for cooling the conductor 23 may be a method for cooling the conductor 23 with a cooled liquid. For example, as shown in FIG. 6, a cooled liquid 63 is stored in a tank 61. The flat copper wire 23A is caused to travel through the cooled liquid 63. When traveling through the cooled liquid 63, the flat copper wire 23A is cooled. Examples of the cooled liquid 63 include water, the wire drawing lubricant 43, and so on. The temperature of the cooled liquid 63 is preferably less than 26° C. and is more preferably 25° C. or less.

(2) In the first embodiment, the flat wire drawing machine 11 may comprise only one of the first cooling section 37 and the second cooling section 39. In the first and second embodiments, some or all of the first cooling section 37, the second cooling section 39, and the third cooling section 53 may be used in combination.

(3) The manufacturing apparatus 1 may manufacture enameled copper wires other than the flat enameled copper wire and, for example, may manufacture a round-shaped enameled copper wire. The cooling section may cool the conductor 23 having a round shape around the round wire drawing machine 5.

(4) In the third embodiment, the liquid jetted out from the jet nozzles 35 may be a liquid other than the wire drawing lubricant 43. Examples of the liquid other than the wire drawing lubricant 43 include water, an aqueous solution, and so on.

(5) In the third embodiment, the number of the jet nozzles 35 may be other than two and, for example, may be one, three, four, five, etc.

(6) In the fourth embodiment, the nozzle units 93A and 93B may each comprise only one of the coolant flared nozzles 101, 103, and 105. In the fourth embodiment, the respective coolant flared nozzles 101, 103, and 105 of the nozzle units 93A and 93B may each include one slit-shaped hole extending along the traveling direction TR instead of the multiple holes 111. In this case, the wire drawing lubricant 43 is jetted out from the entirety of the slit-shaped hole.

In the fourth embodiment, the respective coolant flared nozzles 101, 103, and 105 of the nozzle units 93A and 93B may each include a single hole instead of the multiple holes 111. In the fourth embodiment, the nozzle units 93A and 93B may each comprise two, or four or more, coolant flared nozzles.

In the fourth embodiment, the nozzle units 93A and 93B may each comprise a single coolant flared nozzle, and this coolant flared nozzle may include a single slit-shaped hole extending along the traveling direction TR.

In the fourth embodiment, the nozzle unit 93B may be in a position other than below the flat copper wire 23A. For example, the nozzle unit 93B may be in a position, such as beside, diagonally below, or diagonally above the flat copper wire 23A. In the fourth embodiment, the flat wire drawing machine 11 does not necessarily have to comprise one of the nozzle units 93A and 93B.

(7) In each embodiment described above, the cooling section is a unit configured to cool the copper wire. To cool the copper wire refers to, for example, to lower the temperature of the copper wire as compared with a case in which the cooling section is not provided. To cool the copper wire refers to, for example, to lower the temperature of the copper wire as compared with a state before the cooling section acts.

The cooling section cools the copper wire using, for example, a substance with a lower temperature than the copper wire. The cooling section cools the copper wire by, for example, bringing it into contact or close proximity with a substance with a lower temperature than the copper wire. The form of the substance to be brought into contact or close proximity with the copper wire is, for example, a solid, a liquid, or a gas. The liquid is, for example, the wire drawing lubricant 43, water, an aqueous solution, or the like. The gas is, for example, air, nitrogen, or the like. For example, the cooling section jets out, drips, or applies the cooled liquid or gas onto the copper wire. A method for jetting out, dripping, or applying the cooled liquid or gas includes, for example, a method using a nozzle or the like.

The cooling section allows the copper wire to pass through, for example, the cooled solid, liquid, or gas. In this case, the cooled solid, liquid, or gas is, for example, contained in a container. The container has a function of, for example, cooling the cooled solid, liquid, or gas.

In each embodiment described above, the copper wire is made of copper or a copper alloy, or is a wire containing copper or a copper alloy as a main component. The copper wire has a linear form.

(8) Function/functions of a single element in each embodiment described above may be performed by two or more elements in a shared manner, and function/functions of two or more elements may be performed by a single element. Part of the configuration in each embodiment described above may be omitted. At least a part of the configuration in each embodiment described above may be added to or replace the configuration in another embodiment described above.

(9) In addition to the above-described manufacturing apparatus for the enameled copper wire, the present disclosure may be embodied in various forms, such as a system including the manufacturing apparatus as a component, a conductor cooling method, and a conductor cooling device.

What is claimed is:

1. A manufacturing apparatus for an enameled copper wire, the manufacturing apparatus comprising:
a wire drawing section configured to continuously perform cold wire drawing, using a wire drawing die, on a copper wire that is traveling, thereby producing a copper drawn wire;
an application and baking section configured to apply an enamel coating material to a surface of the copper drawn wire and to bake an obtained coating material film; and
a cooling section configured to cool the copper wire so that a temperature of the copper drawn wire at a position that is forward of an outlet-side end face of the wire drawing die with respect to a traveling direction of the copper wire and that is 6 cm apart from the outlet-side end face is 70° C. or less.

2. The manufacturing apparatus for an enameled copper wire according to claim 1,
wherein the cooling section is an air conditioning system of a building in which the manufacturing apparatus for an enameled copper wire is installed, or a unit configured to cool the copper wire with cold air, or a unit configured to cool the copper wire with a cooled liquid.

3. The manufacturing apparatus for an enameled copper wire according to claim 1,
wherein the cooling section is a unit configured to cool the copper wire with a liquid cooled to less than 26° C.

4. The manufacturing apparatus for an enameled copper wire according to claim 3,
wherein the cooling section is a unit configured to apply the liquid to a surface of the copper wire using (a) a nozzle including multiple holes arranged along the traveling direction, (b) two or more nozzles arranged along the traveling direction, or (c) a nozzle including a slit-shaped hole extending along the traveling direction.

5. A manufacturing method for an enameled copper wire, the manufacturing method comprising:
continuously performing cold wire drawing, using a wire drawing die, on a copper wire that is traveling, thereby producing a copper drawn wire;
applying an enamel coating material to a surface of the copper drawn wire and baking an obtained coating material film; and
cooling the copper wire so that a temperature of the copper drawn wire at a position that is forward of an outlet-side end face of the wire drawing die with respect to a traveling direction of the copper wire and that is 6 cm apart from the outlet-side end face is 70° C. or less.

6. The manufacturing method for an enameled copper wire according to claim 5,
wherein the copper wire is cooled with an air conditioning system of a building in which a manufacturing apparatus for an enameled copper wire is installed, or a unit configured to cool the copper wire with cold air, or a unit configured to cool the copper wire with a cooled liquid.

7. The manufacturing method for an enameled copper wire according to claim 5,
wherein the copper wire is cooled with a liquid cooled to less than 26° C.

8. The manufacturing method for an enameled copper wire according to claim 7,
wherein the liquid is applied to a surface of the copper wire using (a) a nozzle including multiple holes arranged along the traveling direction, (b) two or more nozzles arranged along the traveling direction, or (c) a nozzle including a slit-shaped hole extending along the traveling direction, thereby cooling the copper wire.
